(19) United States
(12) Patent Application Publication
(10) Pub. No.: US 2009/0152177 A1
(43) Pub. Date: Jun. 18, 2009

(54) OPTICAL PAPER SORTING SYSTEM, METHOD AND APPARATUS

(75) Inventors: Sheldon Greenspan, Toronto (CA); Jose Sequeira, Brampton (CA); James Arthur Daniels, Omemee (CA)

Correspondence Address: DIMOCK STRATTON LLP, 20 QUEEN STREET WEST SUITE 3202, BOX 102, TORONTO, ON, M5H 3R3, CA

(73) Assignee: Hanaar Corp., Mississauga, ON (CA)

(21) Appl. No.: 12/300,556

(22) PCT Filed: May 11, 2007
(86) PCT No.: PCT/CA2007/000826

§ 371 Date: Nov. 12, 2008

Related U.S. Application Data
(60) Provisional application No. 60/747,161, filed on May 12, 2006.
(60) Provisional application No. 60/747,169, filed on May 12, 2006.

(51) Int. Cl. B07C 5/342; G06F 7/06

(52) U.S. Cl. 209/580; 700/223

(57) ABSTRACT

An optical paper sorting system uses diffuse reflectance to identify a sheet of paper, conveyed on a conveyor, as either white or groundwood grade, or white, colour, or mixed grade. In sorting, paper that does not meet a specified minimum requirement, for example, having less than a maximum amount of lignin, is mechanically diverted from a stream of input paper waste to a rejection bin. Otherwise, the paper is directed to a collection bin. The optical paper sorting method may be used to sort paper into different grades that is then recombined to produce a predetermined grade of sorted waste paper.

### TECHNICAL FIELD

This invention relates to sorting systems. In particular, this invention relates to an optical materials sorting system, method, and apparatus for recyclable materials.

### BACKGROUND

Recycling is one of the most environmentally sensible solutions to waste disposal and resource conservation. Many different types of materials can be recycled for reuse, including metals, plastics and paper.

In paper recycling, white copy paper is one of the most valuable of all recyclable paper grades, while newsprint and file folder stock, which have a high concentration of groundwood, are less valuable grades and at times are considered to be contaminants when found in white copy paper. Thus, during the recycling of high grade white paper, it is desirable that the feed be devoid of high groundwood-content material, which would degrade the finished product. Typically paper sorting is undertaken by workers, who visually identify inferior grades and contaminated white copy paper on a conveyor carrying mixed stock and manually separate inferior grades from the higher value white copy paper.

The separated product inevitably contains an undesirably high content of the inferior grades because visual discrimination is often not very effective, particularly when the conveyor is moving at a high speed. Manual sorting is also undesirable for security reasons, where for example the paper to be recycled contains confidential documents destined for shredding.

Sorting can be done automatically by colour detection. However, it is common to encounter groundwood contaminants in the white paper copy paper grade when sorting is based on color, because sensitivity limitations and obscuring of the stock by graphics can result in newsprint and white-colored file folders being graded as white paper.

Furthermore, paper destined for recycling is typically received by a recycler as an incoming volume of mixed paper waste that may be categorised in terms of content as white paper, colour paper, mixed paper and non-paper content. White paper comprises office waste consisting of substantially white paper. Colour paper is office waste without white content. Mixed paper, which comprises paper waste that is not white paper or colour paper, may comprise paper waste with groundwood content, carbon paper, colour folders, adhesives (labels), newspaper, coated magazines, wrap paper, brown kraft paper and waxed paper. It will be understood that “waste” may include pre-consumer, post-consumer, pre-industrial, post-industrial, and recyclable materials, which may be shredded, non-shredded, and commingled, and is not restricted to post-consumer waste paper.

The white, colour, and mixed categories of mixed paper waste may be shredded and combined in various ratios to produce a number of different grades. Five of those possible sorted shredded paper grades are as follows: Computer Print Out (CPO), Super Sorted Office Waste (SSOW also known as OP1), Office Waste (OW also known as SOP, OP2), High Grade Mix (HGM) and Low Grade Mix (LGM or known as filestock or OP3). Each of these paper grades is defined based on specific minimum standards of grade composition in various industry trade publications to meet paper mills' specifications. The mills pay different prices per ton of shredded paper depending upon the grade. Grades may be further defined by ISRI Scrap Specification Circular, distributed by the Institute of Scrap Recycling Industries, Inc., www.isri.org. The grades referenced herein are used only as examples, and are not intended to be limiting in any way.

While mills will accept sorted shredded paper that exceeds the composition specified, the recycler is not necessarily rewarded for providing an enhanced grade of sorted shredded paper. Sorted shredded paper that fails to meet a specified grade is categorised in the first grade whose specifications it exceeds.

The current practice in the paper recycling industry is to simply maximise production of the highest grade of sorted shredded paper, and then maximise production of the next highest grade, and so on. The result of following such a strategy is the inefficient production of sorted shredded paper grades, such that revenue for sorting a given inventory of paper waste is not maximised. This practice leads to excess production of low grade sorted shredded paper that actually exceeds grade requirements. For example, in a manual sorting operation for sorted shredded paper grades of CPO (85% by weight white paper, 15% by weight colour paper), SSOW (15% white paper, 85% colour paper), and OW (10% white paper, 85% colour paper, 5% mixed paper), it has been found that the OW grade shredded paper generated typically comprises far more white paper than is actually required to meet specifications.

### BRIEF DESCRIPTION OF THE DRAWINGS

In drawings which illustrate by way of example only a preferred embodiment of the invention,

FIG. 1 is a graphical representation of the reflectance of white copy paper and groundwood paper showing reflectivity as a function of wavelength, referenced to a perfect diffuser,

FIG. 2 is a table showing the reflectance ranges of white copy paper and groundwood paper within three selected wavelength ranges,

FIG. 3 is a graphical representation of the table of FIG. 2 showing an acceptance-rejection borderline or threshold,

FIG. 4 is a schematic view of a detection device according to the invention,

FIG. 5 is a schematic view of a paper separating apparatus according to the invention, and

FIG. 6 is a schematic view of a paper separating system according to the invention.

FIG. 7 is a side elevation of the flap of the paper separating system.

FIGS. 8a and 8b are schematic representations of methods for sorting the input paper waste by content.

FIGS. 9a, 9b, 9c, 9d, and 9e are schematic representations of the production of a selection of shredded paper grades from the sorted input paper waste.

FIG. 10 is a schematic representation of an apparatus for sorting input paper waste.

### DETAILED DESCRIPTION OF THE INVENTION

Groundwood contains the polymer lignin, which absorbs ultra violet (UV) light. One of the steps in the manufacture of paper is delignification, which involves the removal of lignin from wood pulp. However, the extent of delignification varies depending on the type of paper being manufactured. Paper products such as newsprint and file folders contain substantially higher amounts of lignin compared to regular white copy paper. The higher the lignin content, such as in newsprint, the stronger the absorption in the UV region of the spectrum. Newsprint and other types of paper containing high amounts of groundwood can thus be identified based on the absorption of UV light, which can be determined inferentially by the diffuse reflectance of the paper in the UV range of the spectrum.

When a beam of light impinges on the surface of a sheet of paper, it is either absorbed or diffusely reflected depending on the quality of the paper. The degree of absorption and reflectance varies with the wavelength of the light and the ‘whiteness’ of the paper. Spectral diffuse reflectance measurements show that regular white copy paper has a substantially higher diffuse reflectance compared to groundwood in the UV region. This difference is due to the lignin content, which has a high affinity for UV light, resulting in a very strong absorbance in the UV region.

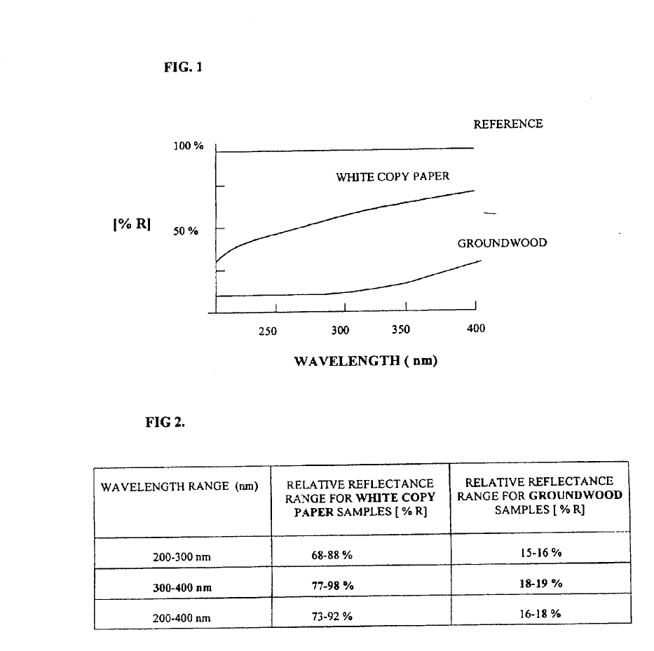

A perfect diffusing surface reflects all light incident upon it. FIG. 1 shows the percentage reflectance (% R) curves, in the 200-400 nm (UV) wavelength spectral range, for white copy paper, newsprint and a known reference surface having perfect diffusivity. The % R is a relative reflectance, calculated as follows:

$$[ \% R ] = \frac{\begin{matrix}Absolute Intensity Of Reflected \\ Light from Sample\end{matrix}}{\begin{matrix}Absolute Intensity Of Reflected \\ Light from Reference\end{matrix}} \qquad ( 1 )$$

In measuring % R the colour, intensity and orientation of the incident light beam should be exactly the same for both the samples and the reference. This eliminates the need to measure the intensity of the incident light.

The curves in FIG. 1 illustrate that groundwood exhibits a much lower relative reflectance compared to white copy paper, throughout the 200-400 nm range, referenced to a perfect diffuser.

FIG. 2 shows the relative reflectance range for a white copy paper samples and newsprint samples in the 200-300 nm, 300-400 nm and 200-400 nm ranges of UV light. The relative reflectance values are referenced to a sheet of white copy paper visually selected to be best representative of the desired white grade. Although all UV regions shown exhibit a similar difference in reflectance levels between white copy paper and groundwood, the 300-400 mn range is preferred for safety reasons.

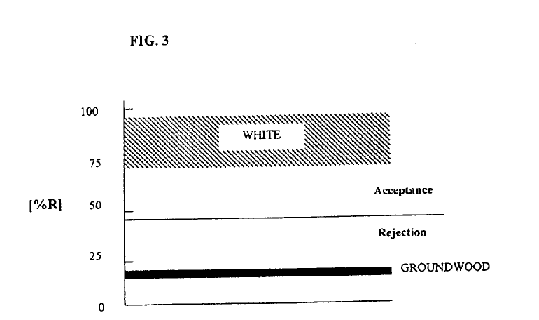

FIG. 3 graphically illustrates the data in the table of FIG. 2, and shows the acceptance-rejection border line which determined by calculating the midpoints of the upper limit of the groundwood relative reflectance range and the lower limit of the white relative reflectance range, as shown below.

[% R]_{TS}=[% R]_{high} groundwood+([% R]_{low} white−[% R]_{high} groundwood)/2 (2)

where

[% R]_{TS} is the Threshold Relative Reflectance,

[% R]_{high} groundwood is the upper limit of groundwood relative reflectance range,

and

[% R]_{low} white is the lower limit of white relative reflectance range.

Using formula (2), [% R]_{TS} has been calculated to be 44% in the 200-300 nm UV light range. The acceptance/rejection algorithm can be expressed as follows;

IF [% R]<[% R]_{TS}

SHEET=“GROUNDWOOD”

ELSE

SHEET=“WHITE”

FIG. 5 is a schematic representation of an apparatus according to the present invention. The apparatus comprises a detection device 10 and an ejection system 40.

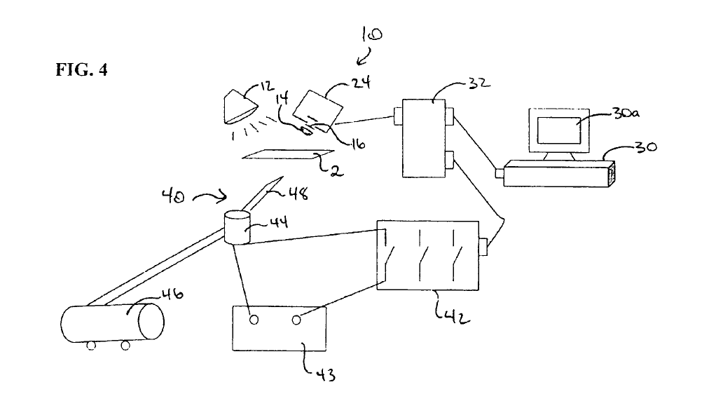

The detection device 10, illustrated in FIG. 4, includes a light source 12, preferably a mercury vapor light source, which fully illuminates a sheet of paper 2 with a light beam that includes a UV spectral component in the desired range. A paper sheet 2 may comprise a piece of paper received from a source of recyclable paper material without further processing, or a paper coupon produced by a shredding process.

In the embodiment shown a plano convex lens 14 collects and collimates the diffusely reflected light. The collimated light is filtered though a UV filter, for example a U-340 Hoya (trademark) filter 16, which isolates the 300-400 nm band. It will thus be appreciated that the light source 12 may be a full spectrum or standard “white” light source which illuminates the sheet 2 in many spectral ranges outside of the UV range, for example visible light regions of the spectrum, because the filter 16 blocks all wavelengths except for those in the selected UV region. Even where the light source 12 is a UV light source confined substantially to the selected UV light region, the filter 16 would be necessary to block light in the visible region of the spectrum produced through fluorescence.

The filter 16 is positioned in front of an aperture 22 through the wall of an opaque detector housing 11 containing a suitable optical detector 24, for example a gallium nitride detector, positioned directly behind the aperture 22. The housing 11 is positioned in a convenient location with the aperture 22 facing the sheet of paper 2. The housing 11 prevents ambient light from striking the detector 24, so that the detector 24 generates a photoelectric current which is directly proportional to the intensity of light diffusely reflected from the paper sheet 2.

In the paper separating apparatus of the invention the detection device 10 is disposed adjacent to the conveyor 4 such that incident light emitted from the light source 12 and diffusely reflected off of the paper sheet 2 traverses the aperture 22 and strikes the detector 24. In the embodiment shown the sheets 2 are supported on top of the conveyor 4 by gravity, and the device 10 is thus positioned above the conveyor 4. In other embodiments, where for example the sheets 2 are retained on the conveyor 4 by air suction or other mechanical means, the conveyor 4 may be oriented in any fashion and the detection device 10 would be positioned accordingly, so that incident light from the light source 12 reflects off of the sheet 2 and enters the aperture 22 of the detector housing 11.

The level of the electrical signal generated by the detector 24 may be measured by any suitable instrument and manually compared against a reference level. However, the preferred embodiment of the invention is automatic and includes a data processing device, such as a personal computer or microcomputer 30, which processes the reflectance values generated by the detector 24 and operates the ejection system 40 in the paper separating apparatus. The photoelectric current generated by the detector 24 is carried by a suitable connection to an analog input port of an analog to digital converter 32, which digitizes the signal and outputs the digital equivalent signal to the computer 30, for example through a parallel connection. The computer 30 is programmed to receive data representative of the intensity of each signal, calculate the relative reflectance of the sheet 2 and apply the algorithm set out above to determine whether the sheet 2 is classified as ‘white’ or ‘groundwood’.

Preferably the computer 30 is also programmed to display the absolute value of digitized signal, the computed value of % R and the type of paper (‘white’ or ‘groundwood’) on a monitor 30a. The computer 30 is further programmed to output either a high or low logic signal depending on which of the two classes of sheets (white or groundwood) has been detected, the high logic signal being an ejection signal which activates the ejection system 40. Preferably, because groundwood normally occurs in smaller quantities in the mixed stock, groundwood is selected as the grade to be ejected. Thus, for example, the paper separating apparatus may be used to separate white from non-white input paper waste, or white and colour paper waste from mixed paper waste, if mixed paper waste may be identified by a higher average lignin content than non-mixed paper waste.

Thus, when the output from the computer 30 is low, no ejection signal is generated; when the computer 30 determines that a sheet of paper 2 falls into the ‘groundwood’ class, it outputs an ejection signal. In the embodiment shown the ejection signal is transmitted back to the AD converter 32 over the parallel cable connection with the computer 30, and the AD converter 32 in turn sends a digital output signal to the relay switch 42 to activate the ejection system 40. Alternatively, the ejection signal may be transmitted directly to a relay card associated with the relay switch 42 to activate the ejection system 40.

The ejection system 40 releases a momentary blast of air to divert a sheet 2 of groundwood paper from the primary collection bin 6 to a rejection bin 8. The bins 6, 8 are thus positioned adjacent to the end of a conveyor 4 such that a sheet 2 reaching the end of the conveyor 4 will fall into the primary collection bin 6 unless diverted to the rejection bin 8, as shown in FIG. 5. The conveyor 4 should preferably be black or dark-coloured, to reduce opportunities for light reflecting off of the conveyor 4 to enter the aperture 22 and strike the detector 24.

The ejection system 40 comprises relay switch 42, one terminal of which is connected to a two-way normally closed solenoid valve 44 and the other terminal of which is connected to one terminal of a power supply, for example a conventional 120 V mains power supply 43. The other terminal of the power supply is connected to the solenoid valve 44 to form a circuit through the relay switch 42, solenoid valve 44 and power supply. A compressor 46 is in communication with an air nozzle 48 connected to the outlet port of the solenoid valve 44 and directed at the terminal end of the conveyor 42, to divert a rejected sheet of paper 2 into the rejection bin 8.

In operation, the conveyor 4 is activated and sheets 2 of paper are fed onto the conveyor 4 upstream of the detector housing 20, either manually or by any suitable mechanical feeding means (not shown). The conveyor 4 conveys the sheets 2, one at a time, past the detector housing 20. As each sheet 2 passes the housing 20 light from the light source 12, collimated by the lens 14, strikes the sheet 2 and reflects through the filter 16 into the aperture 22, striking the detector 24. The detector 24 generates an analog electrical signal proportional to the intensity of light striking the detector, which signal is digitized by AD converter 32 and output to the computer 30.

The computer 30, having been programmed with the appropriate algorithms and a reference level, calculates the percent reflectance of the sheet 2 and compares the % R value to the preprogrammed acceptance-rejection threshold. If the calculated % R is above the acceptance-rejection threshold, the computer 30 outputs a logic low signal (or no signal) and the sheet 2 is conveyed to the terminal end of the conveyor 4 where it falls into the primary collection bin 6.

If the calculated % R is above the acceptance-rejection threshold, the computer 30 outputs a logic high signal to activate the ejection system 40. When the relay switch 42 receives the high input signal from the computer 30, the relay switch 42 closes and completes the circuit, causing a current to pass through the solenoid valve 44, which in turn opens to release a blast of air from the compressor 46 through the air nozzle 48. The distance between the air nozzle 48 and detection device 10, along with the speed of the conveyor 4, determines the time lapse between detection and ejection. The relay switch 42 may be activated after a suitable delay interval, to account for the time taken between detection of the % R from the sheet 2 and conveyance of the sheet to the terminal end of the conveyor 4, however with the conveyor 4 set to a high enough speed and the detection device 10 suitably positioned near the terminal end of the conveyor 4, a delay may be unnecessary.

The air blast causes the sheet of paper 2 to be diverted into the rejection bin 8, which may for example be positioned beneath the terminal end of the conveyor 4, as shown in FIG. 5. The air nozzle 48 is thus mounted beyond the terminal end of the conveyor 4 in such a way that the air nozzle is directed towards the terminal end of the conveyor 4. The undiverted ‘white’ grade sheets 2 fall into the primary collection bin 6 positioned adjacent to the terminal end of the conveyor 4 under the influence of gravity. It will be appreciated that the ejection system 40 can be positioned anywhere downstream of the detection device 10, and the embodiment illustrated is merely a preferred embodiment. It will also be appreciated that the ‘white’ sheets 2 could also be mechanically (pneumatically or otherwise) diverted into the primary collection bin 6, which would allow greater flexibility in the positioning of the bin 6 but would increase the cost of the apparatus.

In the preferred embodiment the duration of the air blast is equal to the length of time the sheet of paper is “viewed” by the detection device 10. The computer 30 can be programmed to time the interval between the start and end of a reflectance signal from the AD converter 32, which respectively correspond to the sheet 2 entering and leaving the view field of the detector 24, and to maintain the high output signal for this interval in order to ensure that the sheet 2 is properly diverted into the rejection bin 8.

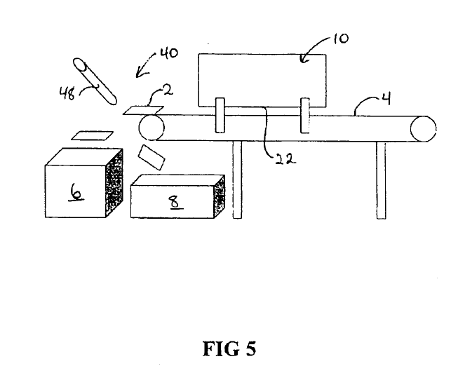

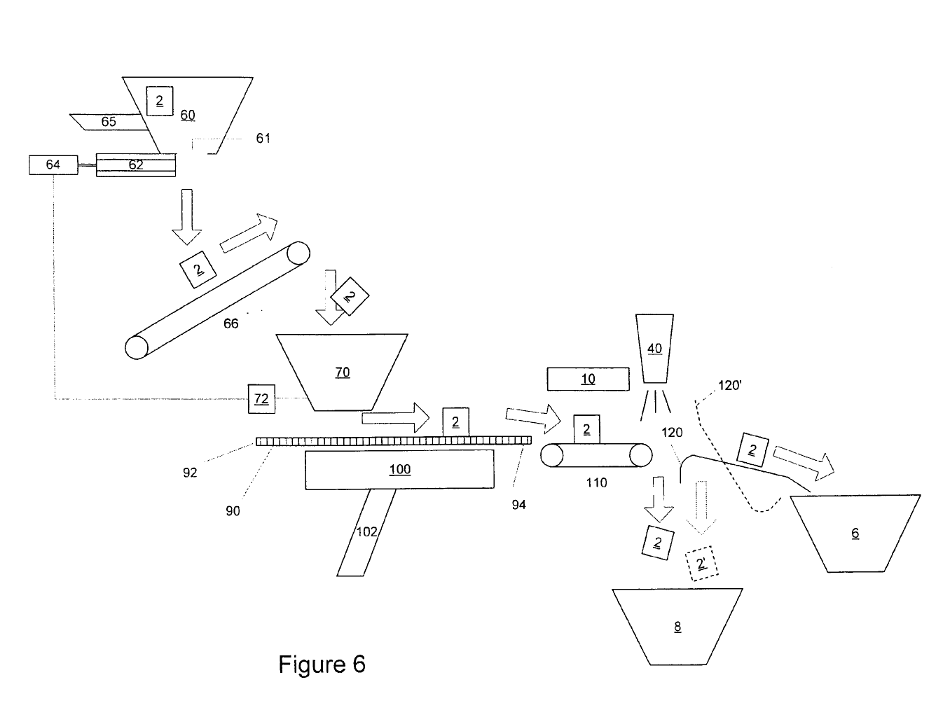

Referring to FIG. 6, a further embodiment of a system for optically characterizing input paper sheets 2 is provided. The system comprises the apparatus described above with reference to FIG. 5, with a detection device IO and an ejection system 40. The system shown in FIG. 6 further comprises a singulation apparatus 60, which receives an input of shredded paper waste for recycling, comprising a volume of individual paper sheets 2. It will be appreciated that such sheets 2 may comprise small particles or coupons of paper, for example pieces of paper produced as a result of a shredding step. The input shredded paper waste may be provided by a shredder (not shown), which receives paper waste provided from a number of sources and produces paper shreds. The paper sheets 2 may be provided by the shredder or another source in a compacted form, which may result in a plurality of paper sheets 2 to stick together; as a result, the effectiveness of optical characterization of the paper sheets 2 would be reduced. Thus, the paper sheets 2 are fed from a shredder to the singulation apparatus 60, which separates the compacted sheets 2. A singulation system suitable for use in this system is described in U.S. Pat. No. 6,634,578 issued to Khalfan and Greenspan, which is incorporated herein by reference. In the preferred embodiment, the paper sheets 2 are released from the singulation apparatus 60 by gravity through an opening 61 onto a conveyance to a buffer 70. It will be appreciated that the paper sheets 2 may be released from the singulation apparatus by another means, for example by propelling the sheets 2 towards the buffer 70 by a jet of air. However the paper sheets 2 are released from the singulation apparatus 60, a gate 62 may be provided at the exit 61 from the singulation apparatus 60, and a separate ejection passage 65 may be provided. The gate 62 preferably comprises a solid form, such as sheet metal, which is driven horizontally (where the sheets 2 are released through the opening 61 by gravity) by an actuator 64, for example a hydraulic, pneumatic, or electric actuator. Upon detection of a signal, a controller operably connected to the actuator 64 may cause the gate 62 to be driven to a closed position, in which the opening 61 is blocked by the gate 62.

From the singulation apparatus 60, the paper sheets 2 are conveyed, for example on a conveyor belt 66, to a buffer 70. It will be understood that all conveyor belts and similar means described herein are preferably enclosed to reduce the likelihood that paper sheets 2, particularly in shredded paper form or in dust form, will escape the system anywhere but through the intended exits and passages. The buffer 70 preferably comprises a sensor, such as a weight or volume sensor, to detect when the buffer 70 is nearing a predetermined maximum capacity of paper sheets 2. The sensor is connected to a signal generator 72, which may comprise lights or other signaling devices to be observed by an operator, or an electric signal generator for use in communicating with the controller operating the actuator 64. When the sensor determines that the buffer 70 is nearing its maximum capacity, it may cause the signal generator 72 to signal to an operator that the buffer is full so that remedial action may be taken (for example, to cease feeding the shredder or singulation apparatus 60 with input paper waste). Alternatively, or in addition to this action, the signal generator may send a signal to the controller for the actuator 64 to activate and close the gate 62, thus preventing further sheets 2 from exiting the singulation apparatus 60 via the exit 61. Any buildup of paper sheets 2 in the singulation apparatus 60 may be removed or ejected through the ejection passage 65. The ejection passage 65 may be connected to a reject bin or baler or the rejection bin 8, for example via a conveyor belt (not shown). This portion of the system thus prevents the buffer 70 from becoming overloaded from the singulation apparatus feed.

From the buffer 70, the paper sheets 20 are deposited on a separation table 90. The separation table 90 comprises a perforated surface, in which the perforations are preferably sized to allow undersized pieces of paper to fall through the table 90 and into a collector 100, which in turn directs the collected reject paper to another ejection passage 102. The ejection passage 102 may be connected to the same reject bin or baler or rejection bin 8 as the earlier ejection passage 65. The separation table 90 may be a vibrating conveyor, which conveys the paper sheets 2 from a first end 92 to a second end 94, while further separating the paper sheets 2 and removing smaller pieces.

From the separation table 90, the paper sheets 2 are preferably transferred to a conveyor 110 and then passed through a detection device 10 such as that illustrated in FIG. 4. In the embodiment shown in FIGS. 6 and 7, the detection device 10 is disposed adjacent to the separation table 90 such that the sheets 2 are supported on top of the conveyor 110 and the device 10 is thus positioned above the conveyor 10. As described above, if the paper sheet 2 is determined by the detection system to have acceptable composition (for example, not considered groundwood paper or not colour or non-white paper), the sheet 2 is delivered to a primary collection bin 6. Here, however, the paper sheet 2 travels over a deflector 120, which is disposed in the “rest” or “default” position (as shown as a solid line in FIG. 6). The deflector 120 thus provides guidance towards the primary collection bin 6. If it is determined that the sheet 2 is not acceptable, then as described above the ejection system 40 will release the momentary blast of air to divert the sheet 2 between the conveyor 110 and the deflector 120, still in the default position, to the rejection bin 8.

While the ejection system 40 employs blasts of air to divert unacceptable sheets 2 to the rejection bin 8, the deflector 120 may be actuated to divert all sheets 2 to the rejection bin 8. This deflector 120 may thus be used to divert the incoming sheets 2 when the detection device 10 determines that there is a high count of unacceptable content arriving on the conveyor 110. A high count of unacceptable content (defects) may be defined as being a certain count of rejected sheets 2 within a specified unit length of time. Since rejected sheets 2 are normally ejected using a blast of air, a persistent high count of rejected sheets 2 may be taxing on the air compressor feeding the air nozzle 48.

The deflector 120 is preferably positioned between the conveyor 110 and the primary collection bin 6 and is pivotably mounted so that it may rotate between the default position and a deflecting position, as shown in phantom as deflector 120′ in FIG. 6. In one embodiment, the deflector 120 may be mounted on a shaft, and may be actuated by a pneumatic cylinder. The deflector 120 may be constructed or formed of a durable material such as metal, and may be provided in the form of a flap. The deflector 120 is controlled by the computer 30 such that when the computer 30 outputs a predetermined signal the deflector is actuated, for example through retraction of the pneumatic cylinder, thus pivoting the deflector 120 to the position shown in phantom lines in FIG. 6. In the deflecting position, sheets of paper 2 that are delivered on the conveyor 110 strike the deflector 120 and are deflected downwards towards the rejection bin 8. When the predetermined signal is discontinued, or when a further cancel signal is transmitted from the computer 30, the cylinder is extended and the deflector 120 returns to its default position, thus allowing sheets 2 to pass over the deflector 120 and be delivered to the primary collection bin 6. Thus, it may be desirable to mechanically divert all sheets 2 to the rejection bin 8.

The predetermined signal may be discontinued, or the further cancel signal transmitted, a fixed period of time after the commencement of the predetermined signal, for example 1 or 2 seconds. Alternatively, the predetermined signal may be discontinued or the cancel signal transmitted when the detection device 10 determines that the count of unacceptable content has dropped sufficiently, in accordance with predetermined thresholds.

This embodiment of the optical sorting system thus provides three means for mechanically diverting the input stream of paper sheets 2 from a path leading to the primary collection bin 8: first at the singulation-buffer feed, next at the separation table, and finally at the detection device. The gate 62 at the singulation apparatus 60 prevents overload of the buffer 70 by diverting the sheets 2 towards an ejection passage 65. The separation table 90 allows for smaller pieces of paper 2, which may not be large enough to be effectively detected by the detection device 10, to be removed from the input to the detection device 10 and instead redirected to an ejection passage 102. Finally, the deflector 120 may be actuated to divert all paper 2 away from the primary collection bin 6 and into the rejection bin 8. The system thus described allows for efficient removal of reject or unsuitable paper 2 and efficient collection of acceptable quality paper sheets 2. It will be appreciated that this system may not only be used in conjunction with the system for detecting materials with a certain composition of lignin, as described above, but also with systems for optically sorting white paper from colour paper, such as that described in Canadian Patent Application No. 2,406,300, which is incorporated herein by reference. Thus it will be appreciated that the device and apparatus of the present invention can be adopted to sort and separate other fibrous objects or objects containing lignin fiber besides paper, utilizing the principles of the invention to differentiate between lignin levels in two or more categories. The invention may also be used to sort and separate paper into more than two categories, by defining a plurality of classification thresholds, increasing the logic output options (for example by outputting to the ejection device a multiple-bit word rather than a high or low signal), and providing a sufficient number ejection systems (i.e. at least one less than the number of classifications) to separate materials of the different classes.

In a further embodiment, a system and method for sorting paper waste to provide an optimum combination of grades of sorted shredded paper waste is provided.

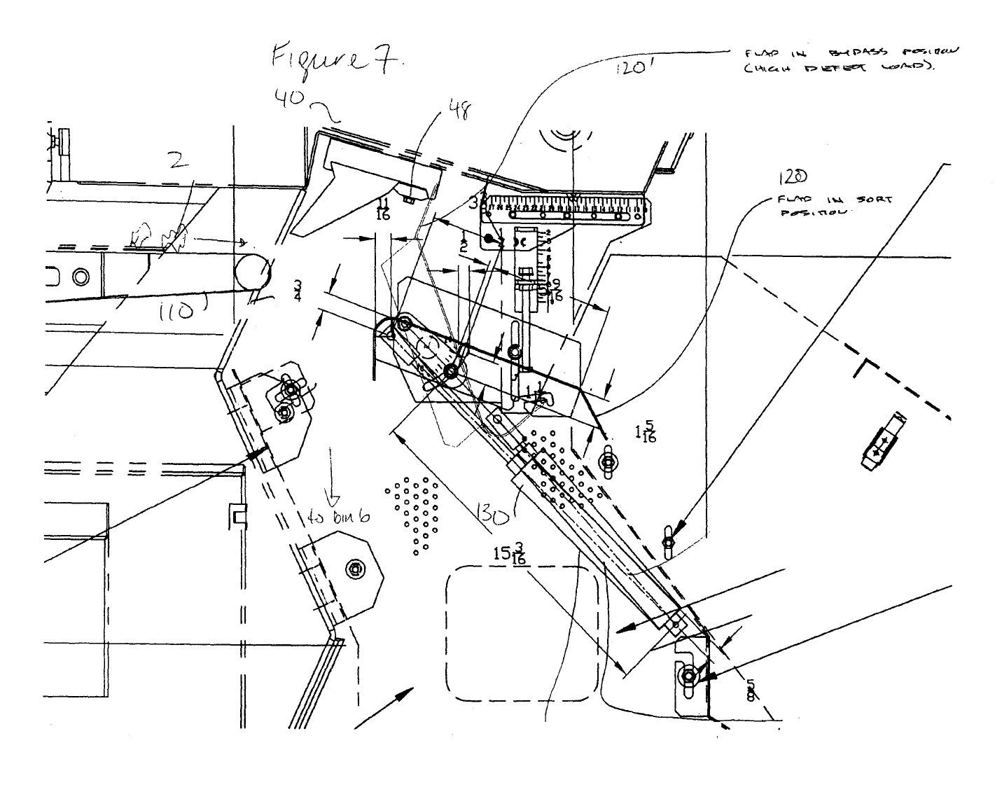

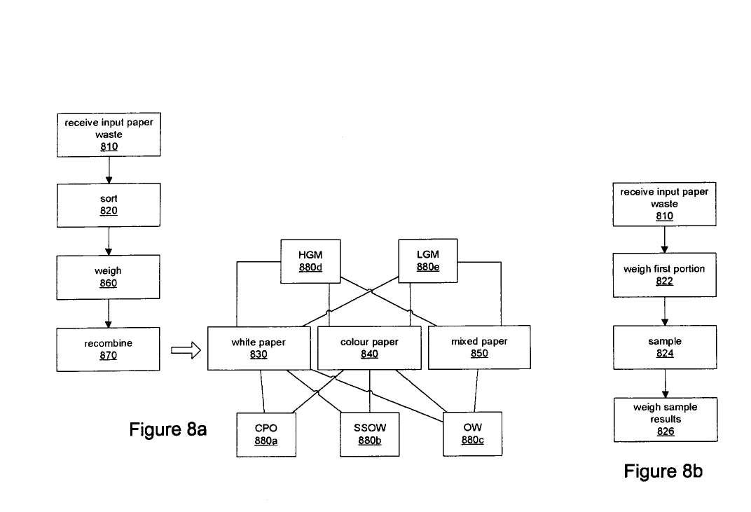

Referring to FIG. 8a, in a first embodiment the method comprises providing input paper waste 810, shredding it if it is not already provided in shredded form, and sorting it by content at step 820 into preferably three categories: white paper 830, colour paper 840 and mixed paper 850. The number of categories applied to the input paper waste may be varied according to the desired amount of control over the quality of each category of paper waste. Each of the three categories of sorted input waste is weighed at step 860. As would be evident to a person skilled in the art, weighing may also be achieved by taking a volumetric measurement of the shredded input paper waste and computing the weight from the known density of the paper. In this first embodiment, it is desirable to provide shredded input paper waste in a pre-sorted form within certain tolerances that can be determined, either by visual inspection or by sampling techniques, as described below. Thus, for example, in this embodiment the white paper 830 is preferably defined as input paper waste comprising white office waste, wherein the content of colour paper and/or mixed paper comprises no more than a fixed percent composition, such as 5%. Colour paper 840 would then be preferably defined as input paper waste comprising no more than a fixed percent composition of mixed paper, for example 5%. The percent composition of the input paper waste is preferably expressed as a percent composition by weight.

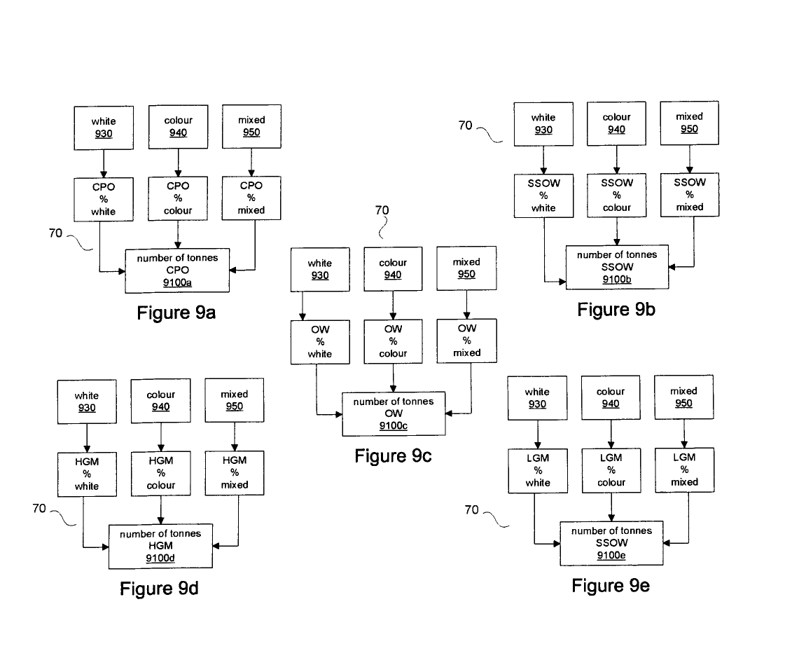

Portions of sorted input waste 830, 840, 850 are then recombined in specified ratios 880a, 880b, 880c, 880d, and 880e at step 870 to produce graded sorted shredded paper. With reference to FIGS. 9a, 9b, 9c, 9d, and 9e, the sorted input waste 930, 940, 950 may be combined to produce Computer Print Out (CPO), Super Sorted Office Waste (SSOW), Office Waste (OW), High Grade Mix (HGM) and Low Grade Mix (LGM) graded shredded paper, although the grades of shredded paper may vary according to the desired specifications. The specified compositions of the shredded paper grades is predetermined; for example, in the preferred embodiment, CPO comprises at least 98% by weight white paper and no more than 2% by weight colour paper, and does not comprise any mixed paper. It is therefore possible, as was done in the prior art, although not necessarily desirable, to generate a quantity of CPO that comprises 100% white paper and does not comprise any colour paper. If all available white paper is used to generate CPO, then there would be no white paper remaining to produce other grades of shredded paper such as SSOW, which may also be defined as comprising a quantity of white paper. All remaining input waste 810 would then be directed to generating lower grades of shredded paper, which are less remunerative than the higher grades of shredded paper. The present invention may be used to determine the optimal usage of the input paper waste to generate the various grades of shredded paper.

The ideal amount of each grade to be produced is determined by considering the composition of the incoming paper waste, the sorting efficiency of the sorting team, the composition specifications of the sorted shredded paper grades, and the current market price for each grade. An estimate of sorting efficiency may be determined by comparing the ideal grade amounts with the actual grade amounts produced.

The ideal amounts of each grade to be produced may be determined by a linear optimisation method such as linear programming. First, initial pre-known starting conditions are defined: the relative weight of each of the sorted input paper types 930, 940, 950, and the market price of each specified grade of sorted shredded paper composed of one or more of the sorted input paper types 930, 940, 950. The relative weights of the input paper types may account for non-paper waste as well, such as binders, metal clamps, fasteners, and actual garbage content that is not recyclable as a paper product. The calculations may provide for an estimated garbage content, for example 5% by weight. The value to be maximized, Z, is the sum of the revenue generated based on the market price per weight of each grade of sorted shredded paper multiplied by the weight of each grade of sorted shredded paper to be produced:

Z=(Price/tonne of CPO)×(No. tonnes CPO)+(Price/tonne of SSOW)×(No. tonnes SSOW)+(Price/tonne of OW)×(No. tonnes OW)+(Price/tonne of HGM)*(No. tonnes HGM)+(Price/tonne of LGM)×(No. tonnes LGM)

Next, constraints are defined: for example, the weight of any input paper for each grade of sorted shredded paper must be greater than or equal to zero, and the total weight of sorted shredded paper produced must be less than or equal to the weight of sorted input paper. Preferably, the total weight of input waste paper is equal to the weight of output sorted shredded paper, taking into account the estimated garbage content. Also preferably, optional constraints may be defined, such as target output weights of specified grades of sorted shredded paper (for example, if no SSOW grade is to be produced, then the weight of that sorted shredded paper grade is equal to zero). Further constraints may also be defined; for example, if it is known that LGM grade sorted shredded paper output is typically 2% of the total paper waste input, this further constraint setting LGM output to 2% of the total input may be imposed. Certain constraints may be defined as binding, meaning the constraint must be met exactly. Other constraints may be non-binding. A constraint that 0 metric tons of SSOW is to be produced, for example, would preferably be defined as a binding constraint, while a constraint that the total weight of input waste paper is equal to the weight of output sorted shredded paper would preferably be defined as non-binding.

As an example, if it is expected that the target grade composition will be exactly met (100% efficiency), sample specifications for output may be provided as follows:

| Grade | White Paper | Colour Paper | Mixed Paper |
|---|---|---|---|
| CPO | 0.98 | 0.02 | 0.00 |
| SSOW | 0.15 | 0.85 | 0.00 |
| OW | 0.10 | 0.85 | 0.05 |
| HGM | 0.00 | 0.05 | 0.95 |
| LGM | 0.00 | 0.00 | 1.00 |

In the table above, white paper is considered to be higher quality input paper waste than colour paper, and colour paper is higher quality input paper waste than mixed paper. Accordingly, a sorted shredded paper grade is met if the proportions of the higher quality input paper waste are met or exceeded, and the proportion of lower quality input paper waste is not exceeded. Thus, a composition of 85% white paper, 13% colour paper, and 2% mixed paper does not meet the minimum 98% standard for CPO; while it does meet the minimum standard for white paper for SSOW, it exceeds the maximum 0% standard of mixed paper; therefore, such a composition would be categorized as OW grade, since it meets or exceeds the minimum white paper composition of 10%, and does not exceed the maximum 5% limit for mixed paper.

Given the above constraints and starting conditions, the optimal output of sorted shredded paper grades is determined such that Z is maximised. This step may be carried out using linear programming techniques, and may preferably be carried out using a numerical method package such as Microsoft Excel Solver™ running on a computer. Use of a numerical method package is preferable, as changes may be made to various constraints or starting conditions and the optimal output and Z recalculated. It will be appreciated that a paper sorting system may be provided with a processor and input and output means for carrying out the method described above. This processor may communicate with sorting machinery, such as the optical characterization systems described below, in order to produce the desired optimal output.

Once the optimal output of each sorted shredded paper grade is determined, the input paper waste 930, 940, 950 may be combined in the amounts defined by the optimal output to produce sorted shredded paper for further processing. Since the optimal grade allotment is known from the outset, workers can avoid under or over sorting the inventory.

However, turning again to FIG. 8a, the input paper waste received at step 810 is frequently received from a number of discrete sources in various compositions of white paper, colour paper, and optionally mixed paper, and it is desirable to avoid performing the discrete sorting operation of step 820. Therefore, in one embodiment, after the input paper waste is received at step 810, it is sampled before generating the various classes of shredded paper grades, and the percent composition of the paper based on the sample results is used to control an optical sorting system. In one embodiment, the sampling step may comprise visual inspection of a portion of one or more discrete sources of input paper waste to assess the approximate percent composition of white paper, colour paper, and mixed paper. For example, if the input paper waste arrives at the recycler in a number of bins or boxes, the contents of part or all of one or more bins or boxes may be visually inspected to determine the composition of the input waste paper. Alternatively, in another embodiment, with reference to FIG. 8b a first portion of the input waste paper may be weighed at step 822 and then sampled at step 824 by passing the first portion through an optical characterization system, such as that described in U.S. Pat. No. 6,335,501 or U.S. patent application Ser. No. 11/349,096, published as U.S. Application 20060124511, which are hereby incorporated by reference. The first portion is passed through the optical characterization system to extract white paper content from the input waste paper and to expel any paper determined to be non-white. The paper thus expelled may be passed through the optical characterization system a second time, or alternatively through a further optical characterization system, in order to extract colour paper from the input waste paper and to expel any mixed paper or refuse included in the white paper content. The white paper and colour paper thus extracted from this first portion is then weighed at step 826 in order to estimate the percent composition of the input paper waste. This information is used to control a further optical sorting process carried out on the whole volume of the input paper waste.

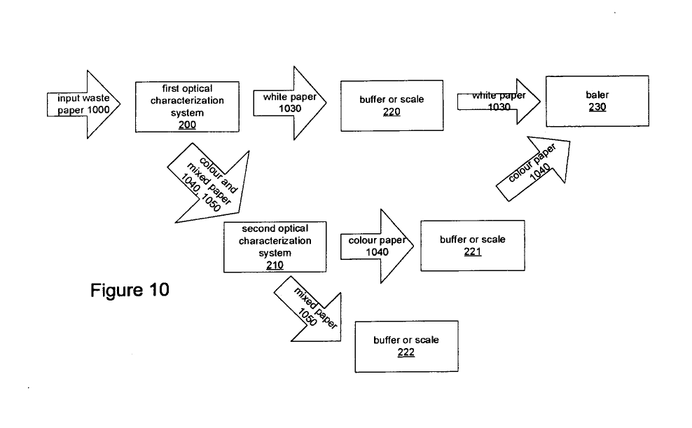

This sampling method comprising one or more optical characterization steps may be performed inline with the further sorting process carried out on the entire input paper waste. The input paper waste may be passed through a series of detectors in an optical characterization system, as described above. Once the sampling is complete, the optimal composition of the sorted shredded paper is determined as described above, and the same optical characterization systems are configured to then sort the input paper waste in accordance with that optimal composition. A first set of detectors, for example, may be used to generate output sorted shredded paper comprising the highest quality of output to be produced; the highest quality output is then output to a baler for delivery to a mill for further processing, while the remaining input paper waste that is separated at the first set of detectors is diverted to a second set of detectors. The second set of detectors is used to generate output sorted shredded paper comprising the next highest quality of output shredded paper to be produced, which in turn is directed to another baler. A further optical characterization system may be provided to further sort the input paper waste that remains in accordance with any remaining grades of sorted shredded paper to be produced and baled. Once it is determined by a processor controlling the optical characterization systems that sufficient quality of a given grade of sorted shredded paper has been produced, the processor may be configured to allow all remaining input paper waste to pass through the optical characterization system associated with that grade, or to reconfigure all of the optical characterization systems in accordance with the remaining output to be generated. A schematic of an exemplary system is shown in FIG. 10. Input waste paper 1000 is passed through a first optical characterization system 200, which separates white paper 1030 from colour and mixed paper 1040, 1050. The white paper 1030 is directed to a buffer or scale 220, which accumulates white paper 1030 until at least a predetermined weight for a single bale has been accumulated; the buffer or scale 220 may comprise a series of buffers fed serially or in parallel from the first optical characterization system 200, for example using conveyor belts, in order to avoid an overflow while waiting for another buffer 221 or 222 to collect sufficient waste paper to compose a bale. The mixed and colour paper 1050, 1040 from the first optical characterization system 200 is diverted to a second optical characterization system 210, which is configured to separate colour paper 1040 from mixed paper 1050; the colour paper 1040 is directed to a second buffer or series of buffers 221, which accumulates colour paper 1040 until at least a predetermined weight for a single bale has been accumulated, and the mixed paper 1050 is directed to a third buffer or series of buffers 222, which accumulates mixed paper 1050. Once the buffers 220, 221, and optionally 222 have collected sufficient material to compose a single bale of sorted shredded paper with a composition as determined by a processor provided with instructions conforming to an optimal output of sorted shredded paper grades as described above, the buffers 220, 221, and 222 provide the necessary content to the baler 230, which compresses the sorted shredded paper into a bale for delivery to a mill for further processing. It will be appreciated that the foregoing system may be implemented using on or more of the apparatus described above.

In a further embodiment, the sampling may comprise an estimation of paper content based on the known characteristics of the source of the input paper waste. Input paper waste is collected from one or more client sources. The source of input paper waste may vary according to client source; for example, some clients may produce paper waste that generally comprises a certain percent composition range of mixed paper or colour paper compared to white paper, and this range may be known based on prior sampling techniques or prior shredded paper grade composition. Therefore, by estimating the weight of the input paper waste from each client, it is possible to determine the optimal output from the input paper waste, and to use the processor to control the optical characterization systems described above.

A preferred embodiment of the invention having been thus described by way of example only, it will be apparent to those skilled in the art that certain modifications and adaptations may be made without departing from the scope of the invention. For example, it will be apparent that the deflector 120 may be employed in optical sorting systems used to sort objects other than paper.

1-20. (canceled)

21. A method for sorting input paper waste to produce at least one of a plurality of sorted paper grades, the method comprising the steps of
sorting input paper waste into at least one of a plurality of input paper waste categories, wherein the plurality of input paper waste categories comprises at least one higher and at least one lower quality input paper waste categories;
determining the quantity of the sorted input paper waste in each of the plurality of input paper waste categories; and
determining an amount of at least one sorted paper grade to be produced from the sorted input paper waste such that a value of the sorted input paper waste is maximized, wherein each sorted paper grade comprises a minimum content of one of the at least one higher quality input paper waste categories and a maximum content of one of the at least one lower quality input paper waste categories, and each sorted paper grade is associated with a value per unit quantity; and
combining quantities of the sorted input paper waste to produce the determined amount of at least one sorted paper grade.

22. The method of claim 21, wherein the composition of at least one sorted paper grade to be produced from the sorted input paper waste is constrained to comprise the minimum composition of the higher quality input paper waste category.

23. The method of claim 22, wherein the composition of an other of the at least one sorted paper grade to be produced from the sorted input paper waste comprises more than the minimum composition of the higher quality input paper waste category.

24. The method of claim 23, wherein the step of determining an amount of at least one sorted paper grade is based on a predetermined sorting efficiency of the other of the at least one sorted paper grade.

25-30. (canceled)

31. The method of claim 21 wherein the plurality input paper waste categories comprise at least a white paper category, a colour paper category, and a mixed paper category.

32. The method of claim 21 wherein at least two of the plurality of sorted paper grades are produced.

33. The method of claim 21 wherein sorting input paper waste comprises separating the at least one higher quality input paper waste category from the input paper waste using a first optical characterization system.

34. The method of claim 21 wherein the plurality of input paper waste categories comprises white paper, and the step of sorting input paper waste comprises separating white paper waste from the input paper waste using a first optical characterization system to provide input non-white paper waste.

35. The method of claim 21 wherein the plurality of input paper waste categories comprises mixed paper, and the step of sorting input paper waste comprises separating the mixed paper waste from the input paper waste using a first optical characterization system to provide non-mixed paper waste.

36. The method of claim 33 wherein sorting input paper waste further comprises separating a second quality input paper waste category from the remainder of the input paper waste after the at least one higher quality input waste category is separated, using a second optical characterization system.

37. (canceled)

38. The method of claim 34, wherein the plurality of input paper waste categories comprises colour paper, and wherein the step of sorting input paper waste further comprises separating colour paper waste from the input non-white paper waste using a second optical characterization system.

39. The method of claim 33, wherein sorting the input paper waste comprises:
conveying input paper waste on a first conveyor towards at least one collector:
determining, using the first optical characterization system disposed adjacent to the conveyor, whether the input paper waste comprises the at least one higher quality input paper waste category:
if the input paper waste comprises the at least one higher quality input paper waste category, directing the input paper waste to a first collector, and if the input paper waste does not comprise the at least one higher quality input paper waste category. directing the input paper waste away from the first collector

40. The method of claim 36, wherein sorting, the input paper waste comprises:
conveying input paper waste on a first conveyor towards a first collector:
determining, using the first optical characterization system disposed adjacent to the first conveyor, whether the input paper waste comprises the at least one higher quality input paper waste category;
if the input paper waste comprises the at least one higher quality input paper waste category, directing, the input paper waste to the first collector; and
if the input paper waste does not comprise the at least one higher quality input paper waste category, directing the input paper waste away from the first collector and to a second conveyor for conveying the input paper waste towards a second collector; determining, using the second optical characterization system disposed adjacent to the second conveyor, whether the input paper waste comprises the second quality input paper waste category, directing the input paper waste to the second collector; and
if the input paper waste comprises the second quality input paper waste category, directing the input paper waste to the second collector; and
if the input paper waste does not comprise the second quality input paper waste category, directing the input paper waste away from the second collector.

41. The method of claim 36, wherein the second quality input paper waste category is the at least one lower quality input waste category.

42. A system for sorting input paper waste to produce at least one of a plurality of sorted paper grades, comprising a computer program product comprising program code which, when executed by a computing device, is operative to:
sort input paper waste into at least one of a plurality of input paper waste categories, wherein the plurality of input paper waste categories comprises at least one higher and at least one lower quality input paper waste categories;
determine the quantity of the sorted input paper waste in each of the plurality of input paper waste categories; and
determine an amount of at least one sorted paper grade to be produced from the sorted input paper waste such that a value of the sorted input paper waste is maximized, wherein each sorted paper grade comprises a minimum content of one of the at least one higher quality input paper waste categories and a maximum content of one of the at least one lower quality input paper waste categories. and each sorted paper grade is associated with a value per unit quantity; and
combine quantities of the sorted input paper waste to produce the determined amount of at least one sorted paper grade.
